(19) United States
(12) Patent Application Publication
(10) Pub. No.: US 2010/0215423 A1
(43) Pub. Date: Aug. 26, 2010

(54) Locking device for ring binder

(76) Inventor: Ronald L. Voller, Bradenton, FL (US)

Correspondence Address: ROBERT A. BROWN, P. O. BOX 2127, NORTHBROOK, IL, 60065-2127, US

(21) Appl. No.: 12/380,269

(22) Filed: Feb. 25, 2009

(51) Int. Cl. B42F 3/04; B23P 19/04

(52) U.S. Cl. 402/31; 29/237.5

(57) ABSTRACT

A locking device for installation in a loose leaf binder that includes a base member secured to a middle section panel or back cover of the binder at a first location of manufacture and a separate ring mechanism for installation in the loose leaf binder at a second geographical location distanced remotely from the initial point of manufacture. The assembly of the ring mechanism to the base member is achieved by structure formed on the base member operable and adaptable to receive complementary shaped members in a permanent and locked relationship therebetween. Separate assembly of component parts permits bulky binders to be shipped in compact stacks that result in great savings of freight and costs of transportation in moving goods between global locations remote from each other.

### FIELD OF THE INVENTION

The present invention relates generally to binders for containing loose leaf pages of stationery and more particularly to locking mechanisms for securing base members having rings mounted thereon to a central back portion of a binder.

### BACKGROUND OF THE INVENTION

Ring binders, most notably three ring binders, come in a variety of sizes and shapes. Typically, a ring binder includes two foldable, oppositely disposed, shaped generally from flat, rectangular, stiff, board-like vinyl, or cardboard members to form an outside cover enclosure for storing therebetween a number of pages that may range from just a few to a hundred or more sheets of paper, plastic, or other similar sheet-like material.

A relatively narrow, middle stabilizer connecting panel member is disposed between the two oppositely disposed, foldable cover members and provides a base for rotating the flat board members, or outside cover panels, at least ninety degrees from an open flat position to a closed position for containing therein a selected number of pages. Thus, the binder, usually as a one piece, integral unit, consists of two outside cover panel members operable to bend or fold about a middle, stabilizing, connecting panel member to form an enclosure adaptable to receive or remove paper pages, or other suitable sheet material from storage therein.

A ring binder is supplied to consumers in the marketplace in a thickness that may vary from less than an inch to as much as five or more inches. In present day commerce, a manufacturer of ring binders must install on a middle portion panel of the binder between its two cover members an elongate base member on which is mounted a ring binder mechanism.

When installed within the binder cover panels, the ring and base member mechanism will result in a binder, depending upon its size, of at least one inch or more of thickness when the outside covers are closed thereabout. The manufacturer must then pile or place together a number of closed binders, usually in a stack wherein one binder is positioned upon a lower binder with its thick portion disposed opposite from the thick portion of the lower binder. This arrangement provides a stack or pile of binders of even height that may facilitate packaging for shipment to a distributor or retail client. The height of the stack, however, depends on the cumulative thickness of each binder and results in an inordinate amount of internal wasted space and an unnecessary height of tiered bulk in a bundle of binders for delivery to a customer. Each bundle would include within each binder an internal trapezoidally shaped volume of dead air space that results in added freight costs transporting finished goods from a source of production to a retail site for purchase by a consumer. This useless and uneconomical volume of space adds greatly to the expense to deliver goods, and for larger, thicker binders, the costs become unmanageable in attempting to provide a consumer an affordable quality product.

The aforementioned observations become even more critical in the climate of today's global economy. It has become common place and ordinary to make all types of goods and products in countries off-shore from the United States in order to take advantage of lower wage rates that prevail abroad in comparison with domestic hourly compensation. Accordingly, transportation costs from countries located in other continents, such as Asia, become a salient factor in determining the price of an end product sold in the United States. Therefore, if a manufacturer can make products thousands of miles from the United States and ship them into domestic markets at minimal freight expense, a distinct competitive advantage has been accomplished and a corporate maker of goods is able to increase its profits and benefits for its shareholders.

### SUMMARY OF THE INVENTION

Therefore, it is a primary object of the present invention to provide a ring binder that includes a locking device for installation within the United States after shipment from a source of manufacture located in a country foreign to the United States.

It is an additional object of the present invention to provide a ring binder that includes an internal locking assembly that avoids the need to employ rivets, eyelets, grommets, studs, and the like.

It is a further object of the present invention to provide a ring binder for shipment from remote geographical locations outside of the United States and domestically install therein a locking mechanism for storage of a plurality of sheet material.

Another object of the present invention is to provide a locking mechanism for a ring binder that includes base plate members secured internally on a middle panel and a ring assembly component that is slideably affixed to the base plate members.

It is an even further object of the present invention to provide a ring binder adaptable for shipment from foreign countries to the United States in minimally sized packages and thereafter having installed therein a ring assembly locking mechanism.

Still another object of the present invention is to provide a ring assembly locking mechanism for secured and permanent installation in a ring binder by slideable insertion into receiving pocket structure disposed upon base plate members affixed to a middle section panel of the ring binder.

The above and further objects are achieved in accordance with the present invention wherein there is provided a binder apparatus for a loose leaf binder wherein a portion of the apparatus is installed at a first global location and the binder is thereafter shipped in a folded down condition to a second global location and another portion of the apparatus is installed thereat, comprising first and second foldable covers having a middle panel therebetween, a generally flat base member secured to said middle panel at said first global location, whereat one of the covers is folded thereover to form a discrete, compact packaging unit, said flat base member comprises a first anchor member secured to a first distal end thereof, a first receptacle member formed on said first anchor member having an open end facing outwardly toward said first distal end of said base member, a second anchor member secured to a second distal end of said base member, a second receptacle member formed on said second anchor member having an open end facing inwardly toward said first distal end of said base member, a binder assembly for attachment to said flat base member at said second global location so as to form a complete loose leaf binder, said binder assembly comprises an elongate support member substantially equal in length to said flat base member, a first connecting member extending from said support member adjacent a first distal end thereof, a second connecting member extending from said support member adjacent a second distal end thereof, said first and said second connecting members having a centerline distance therebetween substantially equal to a centerline distance measured between said first and said second receptacle members, said first and said second connecting members respectively operable to be received in secured arrangement with said open end of said first receptacle member and said open end of said second receptacle member when simultaneously inserted therein, whereby said flat base member and said binder assembly are permanently installed between foldable covers of a loose leaf binder.

Further, there is provided a method for making a loose leaf binder wherein initial assembly of the apparatus is made at a first global location and final assembly thereof is made at a second global location, comprising the steps of forming first and second covers to fold about a middle panel positioned therebetween, securing a generally flat base member to said middle panel, folding one of said covers over the other cover and said middle panel, forming said covers and said middle panel into a discrete compact packaging unit, said packaging unit being formed at a first global location, attaching a first base plate member to a first distal end of said flat base member, attaching a second base plate member to a second distal end of said flat base member, shipping said packaging unit to a second global location substantially remote from said first global location, and attaching a ring binder assembly unit to said first base plate member and said second base plate member so as to form a complete loose leaf binder, whereby final assembly of said complete loose leaf binder is accomplished at said second global location.

### BRIEF DESCRIPTION OF THE DRAWING

The foregoing and other characteristics, objects, features and advantages of the present invention will become more apparent upon consideration of the following detailed description, having reference to the accompanying figures of the drawing wherein:

FIG. 1 is a plan view of a binder, commonly referred to as a loose leaf binder, including a plurality of circular, oval or otherwise suitably designed rings operable to open and close to permit sheets of material to be inserted therein and removed therefrom.

FIG. 2 is an end view of a stack of binders illustrating the manner in which the binders may be closely positioned to conserve space when packaged for shipment from a place of manufacture to a marketing area that is far removed or even an intercontinental area remote from a point of origin.

FIG. 3 is an end view of a stack of prior art binders including ring inserts showing the difference in stack bundle height required to package an equivalent number of binders for long distance transportation between a location of origin and an ultimate, distant, geographical destination point of sale.

FIG. 4 is a cut-a-way perspective view of a ring binder of the present invention showing details of internal structure including base plates attached to a central portion of a foldable binder that receive complementary, extended circular members affixed to a ring binder in a secure locked position.

FIG. 5 is a sectional, partial, side view of a ring binder of the present invention taken along the line 5-5 of FIG. 4 depicting details in the manner of attachment between a base plate and a thickness of a central portion of a foldable binder material.

FIG. 6 is a perspective, partial, fragmented, elevational view of a base plate member and a circular locking member of the present invention taken along the line 6-6 of FIG. 4 wherein the locking member is positioned for insertion into and secure attachment with complementary structure of the base plate member.

FIG. 7A is a sectional, fragmented, side elevational view of a base plate member and a circular locking member of the present invention taken along line 7-7 of FIG. 6 showing a first stage of inserting the locking member into complementary structure of the base plate member.

FIG. 7B is a sectional, fragmented side elevational view of a base plate member and a circular locking member of the present invention taken along line 7-7 of FIG. 6 showing a second stage of inserting the locking member into complementary structure of the base plate member.

FIG. 7C is a sectional, fragmented side elevational view of a base plate member and a circular locking member of the present invention taken along line 7-7 of FIG. 6 showing a third stage of inserting the locking member into complementary structure of the base plate member wherein the locking member is securely attached to complementary structure of the base plate member.

FIG. 8 is a cut-a-way perspective view of a ring binder of the present invention similar to FIG. 4, but showing details of external structure of the base plates attached to a central portion of a foldable binder and the manner in which complementary, extended circular members are positioned for insertion into receptacles of the base plates for attachment in a secure locked position therebetween.

FIG. 9 is a cut-a-way, sectional, side elevational view of a ring binder of the present invention taken along the line 9-9 of FIG. 8 illustrating a compact, homogeneous, integral relationship between a base plate assembly and a central portion of material comprising a foldable ring binder.

FIG. 10 is a perspective, fragmented, elevational view of an alternate embodiment of a base plate member and a locking member of the present invention positioned for assembly into locked secure attachment.

FIG. 11 is a sectional, fragmented, side elevational view of a base plate member and a locking member of the present invention taken along line 11-11 of FIG. 10 showing a snap and stop member for maintaining the locking member in a locked position after insertion engagement with the base plate member.

FIG. 12 is a perspective, fragmented, elevational view of an alternate embodiment of a base plate member of the present invention showing structure to facilitate insertion of the locking member into secured attachment therebetween.

FIG. 13 is a sectional, fragmented, side elevational view of a base plate member of the present invention taken along line 13-13 of FIG. 12 depicting in detail internal structure to facilitate and maintain the locking member in a locked position.

FIG. 14 is a perspective view of a base plate member of the present invention showing an alternate configuration of receiving structure thereon including an aperture that serves to receive the locking member therein and after movement thereof into contact with serrations maintains the assembly in secure locked arrangement.

FIG. 15 is a fragmented, plan view of a base plate member of the present invention similar to FIG. 14, further illustrating a manner wherein a locking member is inserted into the base member and moved into locked contact with serrations of the base member.

FIG. 15A is a fragmentary, side elevational view of the base plate member shown in FIG. 15 wherein a locking member is inserted into a first position of an opening, guided into a second position of a slot and secured thereat with serrations formed thereon.

FIG. 16 is a perspective, fragmented elevational view of a base plate member and an elongate ring mounting member of the present invention showing an additional alternate structure of assembly wherein the base plate member includes a mounting post for receiving an aperture of the ring mounting member and subsequent movement of the ring mounting member causes the post to move into a slot thereon so as to maintain the assembly in a secure locked relationship.

### DESCRIPTION OF A PREFERRED EMBODIMENT

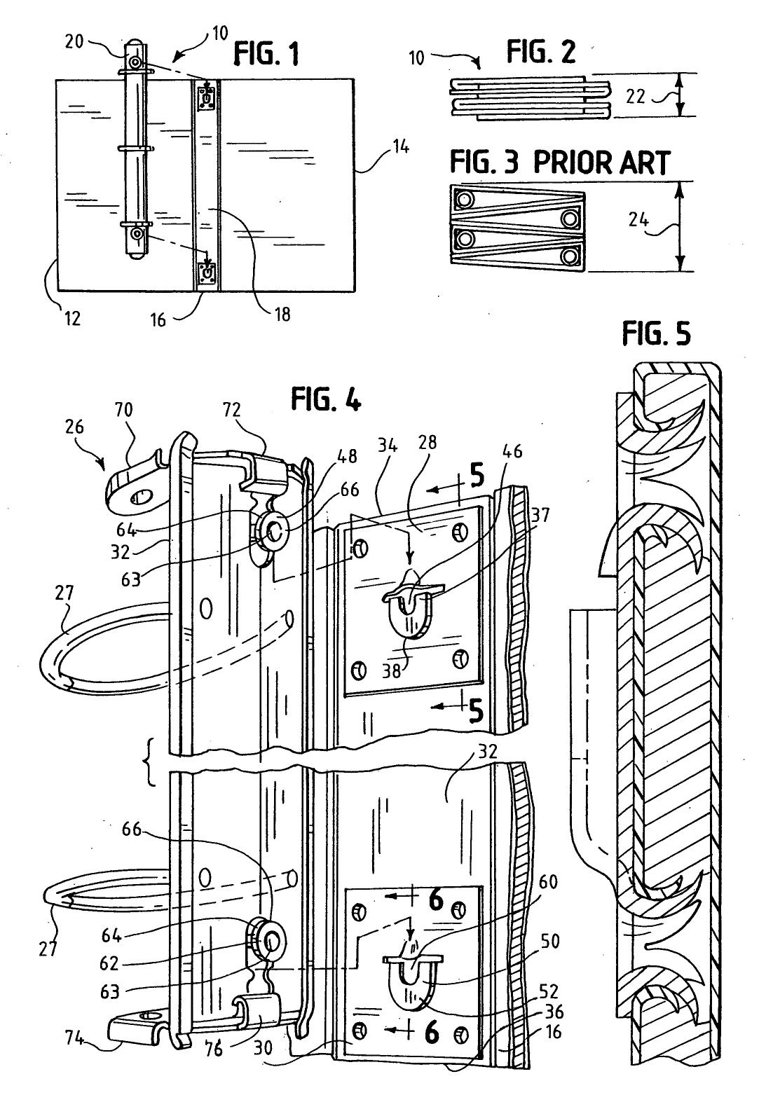

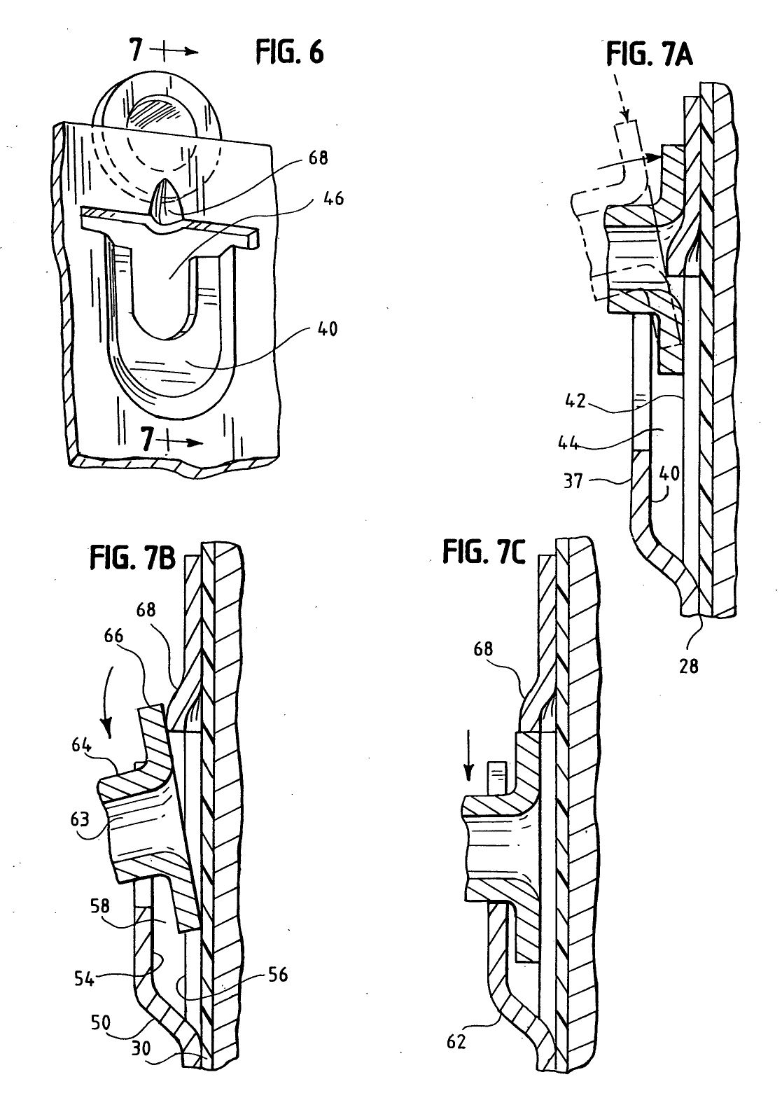

Referring to the several views of the drawing wherein like parts are identified by like reference numerals, and more especially to FIG. 1, there is shown a ring binder, generally identified by reference numeral 10, displayed as an open book, with a first side cover 12 and a second side cover 14. The binder 10 has a middle section 16, an optional base member 18 that may be affixed thereto and a ring mechanism 20 disposed separately from the base member 18, but positioned for subsequent permanent attachment directly to the middle section 16 or alternately to the base member 18.

In FIG. 2 a plurality of closed binder covers are placed or otherwise positioned one on top of another to form a stack or pile of binders that may be packaged for shipment from a source of manufacture to a marketplace. It should be noted that the number of binders stacked to form a package suitable for transportation, while shown as four, might total any number of binders considered feasible to form an economic shipment package. A dimensional arrow 22 illustrates the height of a stack of closed binders 10 positioned for packaging and later shipment to a client.

FIG. 3 shows a number of bundles stacked in a prior art orientation wherein each binder includes an internal ring assembly attached to a middle section having a width or thickness that results in a cumulative height of stacked prior art bundles significantly greater than an equal number of stacked closed binders. It should be noted in FIG. 3 that a trapezoidally shaped volume of dead air space is disposed between the first and second binder covers. The combination of middle section thickness with this dead air space causes the overall height of a prior art binder stack to be much greater than an equal number of closed binders stacked in accordance with the present invention. A dimensional arrow 24 having a length much greater than the dimensional arrow 22 illustrates the significant difference between the height of a stack of closed binders (FIG. 2) and that of the prior art binders of FIG. 3.

FIG. 4 depicts a ring binder mechanism or assembly, generally identified by reference numeral 26, suitably secured to the narrow, middle stabilizer panel member 16. The binder mechanism 26 comprises a first base plate member 28, a second base plate member 30 and an elongate metal or other suitably strong material support member 32. The first base plate member 28 is disposed on the middle section panel 16 adjacent a first distal end 34 of the middle section panel 16. Similarly, the second base plate member 30 is disposed on the middle section panel 16 adjacent a second distal end 36 thereof.

The ring binder mechanism 26 mounted on the intermediate section panel 16 is disposed so that the two side cover panels 12, 14 are operable to be bent or folded upwardly substantially ninety degrees and thereby form a complete ring binder. The ring binder assembly 26 is shown with two rings 27, operable to open and close, but it should be understood the present invention is applicable for any number of rings mounted on a support ember 32 within the binder 10.

The ring binder assembly 26 mounted on first 28 and second 30 base plates is secured to the middle section panel 16 that has a longitudinal length somewhat less than the height of the ring binder. A known binder mechanism, or operable assembly of component parts, includes a series of two, three or more circular shaped rings or prongs 27 spaced along its length, each prong being operable to rotate simultaneously from open to closed positions, as controlled by an actuating lever. The actuating lever is adaptable to open the prongs so that aperture punched sheets of material may be inserted thereover. The lever may then be operated so as to close the prongs and secure thereon sheets of paper, for example, stored within the confines of the prongs. In addition, the actuating lever has contained therein a locking member to maintain the prongs in a closed position to ensure that no sheets of paper might inadvertently fall out from mistakenly opened prongs.

Referring to the hereinbefore described arrangement for mounting the ring binder assembly on a middle section panel disposed between the binder covers, it should be noted that this description is for illustrative purposes only, as a preferred means of attachment, and should not be considered as a limiting feature. Loose leaf binders are available in many sizes of middle panel width, ranging from less than an inch to large binders having a middle section of five or more inches in width and thickness of a loose leaf binder. In such large binders, it is common place to mount the ring binder assembly at or near the inside vertical edge of the back cover adjacent the middle section panel. In this embodiment, the ring binder assembly 26 and its rings 27 comprise an overall dimensional measurement that is substantially equal to the width of the middle section panel and allows the front cover to fold over the binder assembly so as to form a loose leaf binder wherein the rings of the binder assembly nest or rest adjacent the middle section panel 18. In this mode, the rings each may be and are usually formed partially in a circular configuration with a generally flat portion disposed along the circumference. In this manner, the rings so formed are operable to receive and accept large numbers of inserted sheets of material to be contained within binders of several inches in thickness. Accordingly, ring binder assemblies of the present invention may be mounted on middle section panels of a loose leaf binder, on a back cover thereof, or other suitable location therewithin. Also, rings provided with the ring binder assembly of the present invention may be completely circular, partially so with a flat circumferential section, or any combination of circular and flat sections considered desirable for receiving and storing multiple pages of paper or other material within a loose leaf binder.

The essence of the invention lies in a preferable, rectangularly shaped first base plate member 28 having formed thereon a first pocket member 37, a likeness that resembles a horseshoe. A generally circular closed end portion 38 of the horseshoe configuration has an internal ceiling surface 40 (See FIG. 7A) raised somewhat from an upper surface 42 of the base plate 28 to provide a pocket space 44 therebetween. An open end 46 of the horseshoe configuration is adaptable to receive a first circular shaped member or collar 48 that extends outwardly from the support member 32 of the ring assembly 26. The pocket member 37 is disposed on the first base plate 28 with its open end 46 facing upwardly or outwardly depending upon whether the binder is in a vertical or horizontal condition of repose.

Similarly, the present invention includes a preferable, rectangularly shaped second base plate member 30 having formed thereon a second pocket member 50, a likeness that resembles a horseshoe. A second, generally circular, closed end portion 52 of the horseshoe configuration has an internal ceiling surface 54 raised somewhat from an upper surface 56 of the second base plate 30 to provide a pocket space 58 therebetween (See 7B). An open end 60 of the horseshoe configuration is adaptable to receive a second circular shaped member or collar 62 that extends outwardly from the support member 32 of the ring assembly 26. The second pocket member 50 is disposed on the second base plate 30 with an open end 60 facing upwardly or inwardly depending upon whether the binder is in a vertical or horizontal condition of repose.

Again referring to FIG. 4, the first 48 and second 62 circular members are each disposed adjacent respective first 34 and second 36 ends of the support member 32. Each circular collar member has formed therethrough a bore 63. Each circular member has an external circumferential grove 64 formed therein and a respective outermost circular flange 66 formed thereabout.

Each circular member 48 and 62 has a diameter sized or dimensioned to be received within a respective pocket member 37, 50, formed on its base plate. The distance from a center of the bore of the first circular member 48 to the center of the bore of the second circular member 62 is substantially equal to the distance from a center of the horseshoe configuration of the first pocket member 37 to a center of the horseshoe configuration of the second pocket member 50. Accordingly, as hereinafter explained in greater detail, the first 48 and second 62 circular members of the support member are operable to be placed and secured within respective first 37 and second 50 pocket members formed on the first 28 and second 30 base plates.

The dotted lines in FIG. 4 that extend from circular members 48 and 62 to pocket members 37 and 50 illustrate and reflect a pattern of movement whereby the ring assembly 26 may be rotated and positioned over the base plates 28 and 30 so that the circular members 48 and 62 can be inserted respectively into pocket members 37 and 50 and secured therein. During this procedure, circular embers 48 and 62 are deployed just above the open ends 46 and 60 (See FIG. 4). The support member 32 is urged downwardly so that members 48 and 62 slide into respective internal pocket spaces 44 and 58 (See FIGS. 7A and 7B), settle therein and are secured thereat as by a detent or spring latch member 68, or other suitable structure that prevents removal of the circular members 48 and 62 from pocket members 36 and 50.

Again referring to FIG. 4, there is shown a first operating lever 70 disposed on the first end 34 of the ring binder support member 32 having an arm 72 that extends underneath and inwardly to open and close the rings 27. Similarly, a second operating lever 74 is located at the second end 36 of the support member 32 having an arm 76 that extends underneath and inwardly to connect with the mechanism operable to open and close the rings 27. It should be noted that actuation of operating levers 70 and 74, either singly or simultaneously, may be capable of and adaptable to open and close the rings 27.

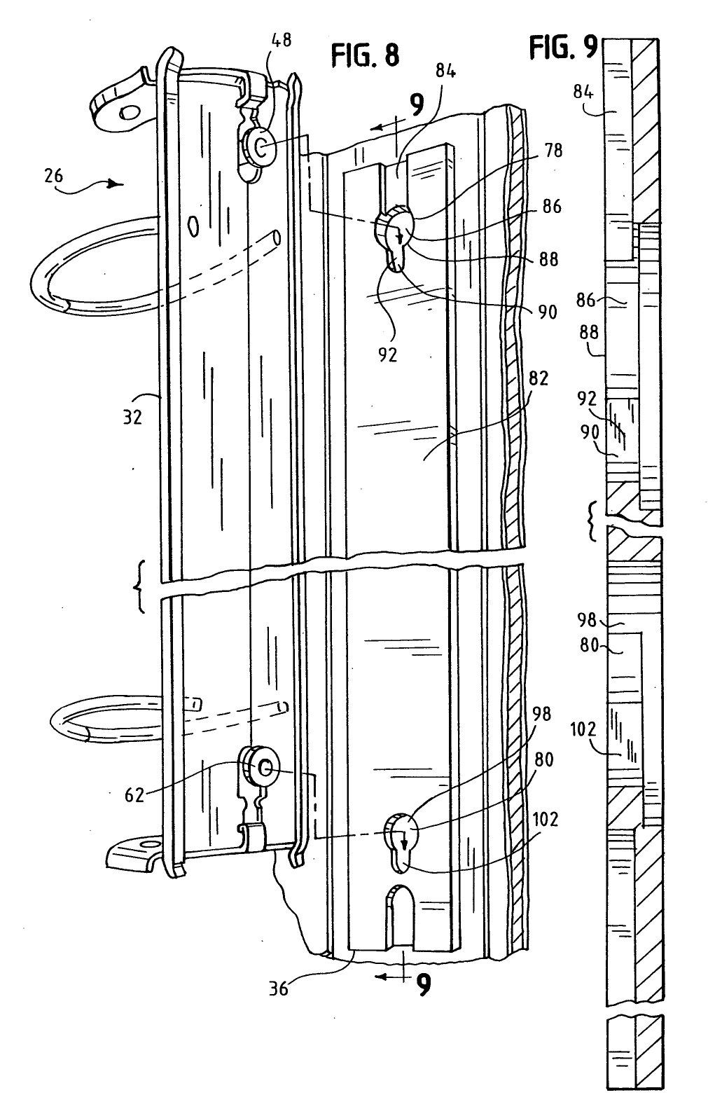

Now referring to FIG. 8, the dotted lines that extend from circular members 48 and 62 to a first 78 and a second 80 keyhole member, respectively, similar to the structure of FIG. 4, depict and reflect a pattern of movement whereby the ring assembly 26 may be rotated and positioned over an elongate, integral, single piece, foundation member 82 that is substantially equal in length to that of the middle section panel 16 and is suitably secured thereto, as by glue, staples, prongs (FIG. 5), or any other desired type or form of attachment. In this mode, it should be noted that the foundation member 82 with its apertures 88 and 98 may be affixed or otherwise suitably secured to an interior space between layers of the middle stabilizing member 16, or on an exterior surface thereof facing forwardly with the two foldable flaps, or covers, to form a loose leaf binder.

The ring binder assembly 26 is poised over the foundation member 82 whereby the first circular or collar member 48 is inserted or fed into a guide track 84, urged inwardly into a first open configuration 86, a large, generally circular portion thereof comprising an aperture 88, of the first keyhole 78.

As the first collar member 48 slides into the aperture 88 of keyhole 78, the second collar member 62 drops into a second aperture 98 of keyhole 80 located at the second end 36 of foundation member 82. Upon further urging and movement of support member 32, the first 48 and second 62 collars are fitted snugly and securely into the first slot 90 of keyhole 78 and a second slot 102 of keyhole 80.

It should be noted that a generally oblong portion of the keyhole member 78 may be formed in the shape of a depressible, tongue-like extension or two-digit finger 92 (See FIG. 8A) having a first distal end 94 terminating at one side of the circular portion of keyhole 78 and being disposed to provide a preselected distance measured from an under side surface 95 of the extended finger member 92 to a bottom side surface 96 of foundation member 82. The distance or height between the bottom side surface 96 of the foundation member 82 and the under side surface 96 of the extended finger 92 may be identified as a notch space 97.

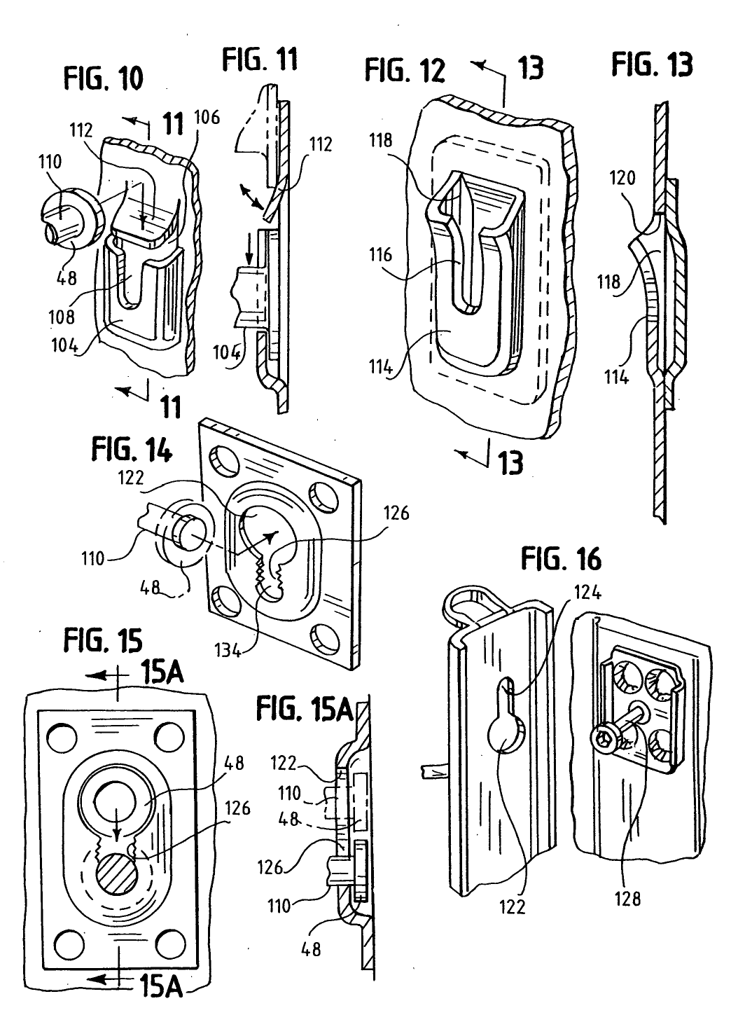

Referring to FIGS. 10 to 16, there are disclosed a number of alternate structural arrangements for receiving the collars 48 and 62 in locked relationship with various pocket and keyhole configurations. In FIGS. 10 and 11, a base plate has formed thereon a generally upright box-like member 104 with an upper opening 106 for receiving the collar 48. A frontal groove 108 is sized to permit a shaft 110 connected to the collar to slide therein so that a spring latch 112 snaps downwardly against the collar 48 to hold it in a secure locked position.

FIGS. 12 and 13 show a slightly modified pocket member 48 in a longitudinally rectangular box-like configuration having a front or outer side 114 bent upwardly and outwardly with a frontal slot 116 for receiving the shaft 110 to slide therein simultaneously with placement of collar 48 in an opening 118. The collar is impeded from moving out of the opening by a side thereof nestled against an edge 120 of the base plate.

FIGS. 14 and 15 disclose a modified structure of securing a collar 48 in a secured position with a pocket member or a keyhole configuration. When the collar 48 is inserted into an opening 122 and urged or moved forwardly so that the shaft 110 slides into a groove 124 having appropriately angled serrations 126, the shaft is held in a locked position that prevents removal of the collar from the pocket member

In FIG. 16, the base plate is shown with an upright shaft 128 mounted substantially centrally thereof so as to extend upwardly through a circular opening in a keyhole formed in the support member 32 of a ring binder assembly. The support member is then urged downwardly so that the shaft 118 slides into a slot of the keyhole and thereby locks the ring binder assembly on the base plate affixed to the middle section 16 or on a back cover 14 of a loose leaf binder. It should be understood that in the preceding description securing or locking a collar to a middle panel or back cover of a loose leaf binder, that the disclosures stated are also applicable to a similar insertion and locking of the collar 62 to a second base plate or to a foundation member.

In the operation of the present invention, a ring binder assembly is placed over a plurality of base plates mounted on a base member affixed to a middle section panel or on a back cover of a loose leaf binder, collar members of the binder assembly are inserted into pocket members or keyhole configurations, the collar members are moved and urged into a snug relationship with the pocket members or the keyhole configurations, and the collar members are locked in this position. The operation of the present invention may also be achieved by attaching a single piece foundation member directly to a middle section panel or a back cover of a loose leaf binder, thereafter inserting collar members into respective pocket or keyhole configurations, and securing the collar members in a locked position thereat.

While the present invention has been described with reference to the above preferred embodiments, it will be understood by those skilled in the art, that various changes may be made and equivalence may be substituted for elements thereof without departing from the scope of the present invention. In addition, modifications may be made to adapt a particular situation or material to the teachings of the present invention without departing from the scope of the present invention. Therefore, it is intended that the invention not be limited to the particular embodiments disclosed for carrying out this invention, but that the present invention includes all embodiments falling within the scope of the appended claims.

I claim:

1. A binder apparatus for a loose leaf binder wherein a portion of the apparatus is installed at a first global location and the binder is thereafter shipped in a folded down condition to a second global location and another portion of the apparatus is installed thereat, comprising
first and second foldable covers having a middle panel therebetween,
a generally flat base member secured to said middle panel at said first global location, whereat one of the covers is folded thereover to form a discrete, compact packaging unit,
said flat base member comprises a first anchor member secured to a first distal end thereof,
a first receptacle member formed on said first anchor member having an open end facing outwardly toward said first distal end of said base member,
a second anchor member secured to a second distal end of said base member,
a second receptacle member formed on said second anchor member having an open end facing inwardly toward said first distal end of said base member,
a binder assembly for attachment to said flat base member at said second global location so as to form a complete loose leaf binder,
said binder assembly comprises an elongate support member substantially equal in length to said flat base member,
a first connecting member extending from said support member adjacent a first distal end thereof,
a second connecting member extending from said support member adjacent a second distal end thereof,
said first and said second connecting members having a centerline distance therebetween substantially equal to a centerline distance measured between said first and said second receptacle members,
said first and said second connecting members respectively operable to be received in secured arrangement with said open end of said first receptacle member and said open end of said second receptacle member when simultaneously inserted therein,
whereby said flat base member and said binder assembly are permanently installed between foldable covers of a loose leaf binder.

2. A binder apparatus as claimed in claim 1 wherein each said first and said second anchor members comprise,
a substantially rectangularly shaped configuration secured to its respective distal end.

3. A binder apparatus as claimed in claim 1 wherein each said first and said second receptacle member is formed to provide a predetermined pocket space for receiving therein a respective said anchor member.

4. A binder apparatus as claimed in claim 3 wherein each said first and said second receptacle member is shaped generally in the form of a horseshoe having a closed end portion that includes an internal ceiling surface spaced from a respective lower surface thereof to form therebetween said pocket space.

5. A binder apparatus as claimed in claim 1 wherein each said first and said second connecting member is sized to be received within a respective said first and said second anchor secured to the flat base member.

6. A binder apparatus as claimed in claim 5 wherein each said first and said second connecting member comprises,
a circular collar member having a bore formed therethrough, an external circumferential grove therein, and an outermost circular flange formed thereabout.

7. A binder apparatus as claimed in claim 6 wherein the distance from a center of the bore of the first circular collar member to the center of the bore of the second circular collar member is substantially equal to the distance from a center of a horseshoe configuration formed on said first receptacle member to the center of a horseshoe configuration formed on said second receptacle member.

8. A binder apparatus as claimed in claim 1 comprising,
at least one actuating lever disposed on an end of the ring binder support member operable at times to open and close a plurality of rings mounted on said support member, and
an arm extending from said operating lever to connect with said operating lever so as to open and close said plurality of rings.

9. A binder apparatus as claimed in claim 1 wherein said first and said second connecting members and mounted on said support member of ring assembly are respectively and simultaneously inserted into said first and said second receptacle members and thereafter secured therein.

10. A binder apparatus as claimed in claim 9 wherein said support member is urged downwardly so that said first and said second connecting members slide into a respective first and second internal pocket space for nesting therein, and
a detent is operable to prevent removal of said support member from said first and said second connecting members.

11. A ring binder assembly apparatus for a loose leaf binder wherein a portion of the apparatus is installed at a first global location and the binder is shipped in a folded down condition to a second global location and another portion of the apparatus is installed thereat, comprising
first and second foldable covers having a middle panel therebetween,
a generally flat foundation member secured at a first global location to said middle panel, whereat one of the covers is folded thereover to form a discrete, compact packaging unit,
said foundation member having a first preselected configuration formed thereon near a first distal end thereof,
said preselected configuration having a partially circular opening formed therethrough with a partial non-circular extension therefrom facing inwardly from said first distal end,
said foundation member having a second preselected configuration formed thereon near a second distal end thereof,
said second preselected configuration having a partially circular opening formed therethrough with a partial non-circular extension therefrom facing outwardly toward said second distal end of said foundation member,
a binder assembly for attachment to said foundation member at a second global location so as to form a complete loose leaf binder,
said binder assembly comprises an elongate support member substantially equal in length to said base member,
a first fastener member extending from said support member adjacent a first distal end thereof,
a second fastener member extending from said support member adjacent a second distal end thereof,
said first and said second fastener members having a centerline distance therebetween substantially equal to a centerline distance measured between said first and said second preselected configuration members,
said first and said second fastener members respectively operable to be received in secured arrangement with said opening of said first preselected configuration member and said open end of said preselected configuration member when simultaneously inserted therein,
whereby said foundation member and said ring binder assembly are permanently installed between foldable covers of a loose leaf binder.

12. A binder apparatus as claimed in claim 11 wherein each said first and said second fastener members comprise,
a circular collar shaped member having a predetermined diameter, a bore formed therethrough, a circumferential groove formed therein, and a flange formed thereabout.

13. A binder apparatus as claimed in claim 11 wherein each said first and said second preselected configurations is formed to provide a predetermined pocket space for receiving therein a respective fastener member.

14. A binder apparatus as claimed in claim 13 wherein each said first and said second preselected configurations is shaped generally in the form of a keyhole having a narrow end portion that includes an internal ceiling surface spaced from a respective lower surface thereof to form therebetween said pocket space.

15. A binder apparatus as claimed in claim 11 wherein each said first and said second fastener members is sized to be received within a respective said first and said second preselected configuration member.

16. A binder apparatus as claimed in claim 15 wherein each said first and said second fastener members comprises,
a circular collar member having a predetermined diameter, a bore formed therethrough, an external circumferential groove therein, and an outermost circular flange thereabout.

17. A binder apparatus as claimed in claim 16 wherein the distance from a center of the bore of the first circular collar member to the center of the bore of the second circular collar member is substantially equal to the distance from a center of a keyhole configuration formed on said first end of said foundation member to the center of a keyhole configuration formed on said second end of said foundation member.

18. A binder apparatus as claimed in claim 11 comprising,
at least one actuating lever disposed on an end of the said support member operable at times to open and close a plurality of rings mounted on said support member, and
an arm extending from said operating lever to connect with said operating lever so as to open and close said plurality of rings.

19. A method for making a loose leaf binder wherein initial assembly of the apparatus is made at a first global location and final assembly thereof is made at a second global location, comprising the steps of
forming first and second covers to fold about a middle panel positioned therebetween,
securing a generally flat base member to said middle panel,
folding one of said covers over the other cover and said middle panel,
forming said covers and said middle panel into a discrete compact packaging unit, said packaging unit being formed at a first global location,
attaching a first base plate member to a first distal end of said flat base member,
attaching a second base plate member to a second distal end of said flat base member,
shipping said packaging unit to a second global location substantially remote from said first global location, and
attaching a ring binder assembly unit to said first base plate member and said second base plate member so as to form a complete loose leaf binder,
whereby final assembly of said complete loose leaf binder is accomplished at said second global location.

20. A method for making a loose leaf binder as claimed in claim 19, comprising the step of
simultaneously inserting first and second fastener members mounted on a support member of said ring binder assembly are respectively inserted into first and second receptacle members disposed on said base member and thereby secured therein.

21. A method for making a loose leaf binder as claimed in claim 19, comprising the steps of
downwardly urging a support member of said ring binder assembly so that first and second fastener members slide into a respective first and second internal pocket space for secured nesting therein, and
providing a detent operable to prevent removal of said support member from said first-and said second fastener members.
